(19) United States
(12) Patent Application Publication
(10) Pub. No.: US 2022/0311021 A1
(43) Pub. Date: Sep. 29, 2022

(54) RESIN FRAME EQUIPPED MEA AND METHOD OF MANUFACTURING THE SAME

(71) Applicant: HONDA MOTOR CO., LTD., TOKYO (JP)

(72) Inventors: Masaru ODA, WAKO-SHI (JP); Takaaki SHIKANO, WAKO-SHI (JP); Shohei TOYOTA, WAKO-SHI (JP); Tatsuro HARUKI, WAKO-SHI (JP); Takashi MOCHIZUKI, WAKO-SHI (JP)

(21) Appl. No.: 17/681,818

(22) Filed: Feb. 27, 2022

(30) Foreign Application Priority Data
Mar. 25, 2021 (JP) 2021-051962
Oct. 19, 2021 (JP) 2021-170967

(51) Int. Cl. H01M 8/0289; H01M 8/0273

(52) U.S. Cl. CPC H01M 8/0289; H01M 8/0273; H01M 2008/1095

(57) ABSTRACT

In a resin frame equipped MEA, an electrolyte membrane has an outer peripheral overlapping portion that overlaps with an inner peripheral portion of a resin frame member. An ion flow blocking member is provided on the outer peripheral overlapping portion. The ion flow blocking member blocks the flow of iron ions, copper ions, or the like. The ion flow blocking member is formed in an annular shape, and surrounds an electrical power generating region of the MEA. The ion flow blocking member can be provided in the form of a physical barrier or a chemical barrier.

### CROSS-REFERENCE TO RELATED APPLICATIONS

This application is based upon and claims the benefit of priority from Japanese Patent Application No. 2021-051962 filed on Mar. 25, 2021 and Japanese Patent Application No. 2021-170967 filed on Oct. 19, 2021, the contents of which are incorporated herein by reference.

### BACKGROUND OF THE INVENTION

### Field of the Invention

The present invention relates to a resin frame equipped MEA and a method of manufacturing the same.

### Description of the Related Art

For example, JP 2006-085926 A discloses a resin frame equipped MEA of an electrical power generating cell for a fuel cell. The resin frame equipped MEA comprises an MEA and a resin frame member. The MEA includes an electrolyte membrane and a pair of electrodes disposed on both sides of the electrolyte membrane. The resin frame member is provided on an outer peripheral portion so as to project outwardly from the outer peripheral portion of the MEA.

The resin frame equipped MEA is sandwiched between a pair of separators. Consequently, the electrical power generating cell is formed. The material of the pair of separators, for example, is a metal such as stainless steel or the like.

### SUMMARY OF THE INVENTION

In the case that the material of the electrolyte membrane is a solid polymer, protons are conducted inside the electrolyte membrane. Such conduction occurs when the electrolyte membrane is wet. Thus, in order to keep the electrolyte membrane in a humidified state, water vapor is mixed in the reaction gases that are supplied to the MEA. In the case that the material of the separator is a metal material, there is a possibility that a portion of the metal material may become eluted by such water vapor. In the case that the metal material is stainless steel, when elution occurs, metallic ions such as iron ions (Fe²⁺) or copper ions (Cu²⁺) are generated.

In the resin frame equipped EMA as described above, metallic ions may pass through inside the electrolyte membrane from an outer peripheral edge of the electrolyte membrane and enter into a central region of the electrolyte membrane (a portion that forms an electrical power generating region of the MEA). When such a situation occurs, there is a concern that the central region of the electrolyte membrane may suffer from deterioration.

The present invention has the object of solving the aforementioned problems.

One aspect of the present invention is characterized by a resin frame equipped MEA of an electrical power generating cell for a fuel cell, comprising an MEA including an electrolyte membrane, a first electrode disposed on a first surface of the electrolyte membrane, and a second electrode disposed on a second surface of the electrolyte membrane, and a resin frame member attached to an outer peripheral portion of the MEA and configured to project outwardly from the outer peripheral portion, wherein the electrolyte membrane includes an outer peripheral overlapping portion configured to overlap with an inner peripheral portion of the resin frame member, an ion flow blocking member configured to block a flow of ions is disposed on the outer peripheral overlapping portion, and the ion flow blocking member is formed in an annular shape surrounding an electrical power generating region of the MEA.

Another aspect of the present invention is characterized by a method of manufacturing a resin frame equipped MEA of an electrical power generating cell for a fuel cell, wherein the resin frame equipped MEA comprises an MEA including an electrolyte membrane, a first electrode disposed on a first surface of the electrolyte membrane, and a second electrode disposed on a second surface of the electrolyte membrane, and a resin frame member attached to an outer peripheral portion of the MEA and configured to project outwardly from the outer peripheral portion, the method of manufacturing comprising a stacking step of obtaining a stacked body by stacking the electrolyte membrane on the first electrode, a joining step of forming an outer peripheral overlapping portion on the electrolyte membrane by superimposing an inner peripheral portion of the resin frame member on the outer peripheral portion of the electrolyte membrane on which the first electrode is stacked, and joining the inner peripheral portion of the resin frame member to the outer peripheral overlapping portion of the electrolyte membrane, and a blocking member forming step of disposing, after the stacking step, an ion flow blocking member configured to block a flow of ions on the outer peripheral overlapping portion of the electrolyte membrane, wherein the ion flow blocking member is formed in an annular shape surrounding an electrical power generating region of the MEA.

According to the present invention, the ion flow blocking member for blocking the flow of ions is positioned on the outer peripheral portion of the MEA. Such an ion flow blocking member prevents the ions from entering from the outer peripheral edge into the central region of the electrolyte membrane. Consequently, it is possible to prevent the central region of the electrolyte membrane from suffering from deterioration due to ingress of ions from an outer peripheral side of the MEA.

The above and other objects, features, and advantages of the present invention will become more apparent from the following description when taken in conjunction with the accompanying drawings, in which preferred embodiments of the present invention are shown by way of illustrative example.

### BRIEF DESCRIPTION OF THE DRAWINGS

FIG. 1 is an exploded perspective view of an electrical power generating cell comprising a resin frame equipped MEA according to a first embodiment of the present invention;

FIG. 2 is a vertical cross-sectional view with partial omission taken along line II-II of FIG. 1;

FIG. 3A is a flowchart illustrating a method of manufacturing the resin frame equipped MEA according to the first embodiment of the present invention;

FIG. 3B is a flowchart illustrating a filling and joining step shown in FIG. 3A;

FIG. 4 is a perspective explanatory view of a stacking step;

FIG. 5A is a cross-sectional explanatory view of a groove forming step;

FIG. 5B is a perspective explanatory view of a machined stacked body after the groove forming step;

FIG. 6 is a cross-sectional explanatory view of a filling step;

FIG. 7 is a perspective explanatory view of a joining step;

FIG. 8 is a cross-sectional explanatory view of the joining step;

FIG. 9 is a flowchart illustrating a filling and joining step according to a modified example;

FIG. 10 is a cross-sectional explanatory view of a coating step and a joining step shown in FIG. 9;

FIG. 11 is a vertical cross-sectional view with partial omission of an electrical power generating cell provided with a resin frame equipped MEA according to a modified example of the first embodiment;

FIG. 12 is a vertical cross-sectional view of principal components of an electrical power generating cell provided with a resin frame equipped MEA according to a second embodiment of the present invention;

FIG. 13 is a chemical structural formula of perfluorosulfonic acid;

FIG. 14 is a flowchart illustrating a method of manufacturing the resin frame equipped MEA according to the second embodiment of the present invention;

FIG. 15 is an enlarged cross-sectional view of principal components showing a state in which a stacked body is formed;

FIG. 16 is an enlarged cross-sectional view of principal components showing a state in which hot pressing is performed;

FIG. 17 is an enlarged cross-sectional view of principal components showing a state in which a liquid (solution) is coated on an electrolyte membrane and a second electrode; and

FIG. 18 is a vertical cross-sectional view with partial omission of an electrical power generating cell provided with a resin frame equipped MEA having an ion flow blocking member in the form of a physical barrier, and an ion flow blocking member in the form of a chemical barrier.

### DESCRIPTION OF THE INVENTION

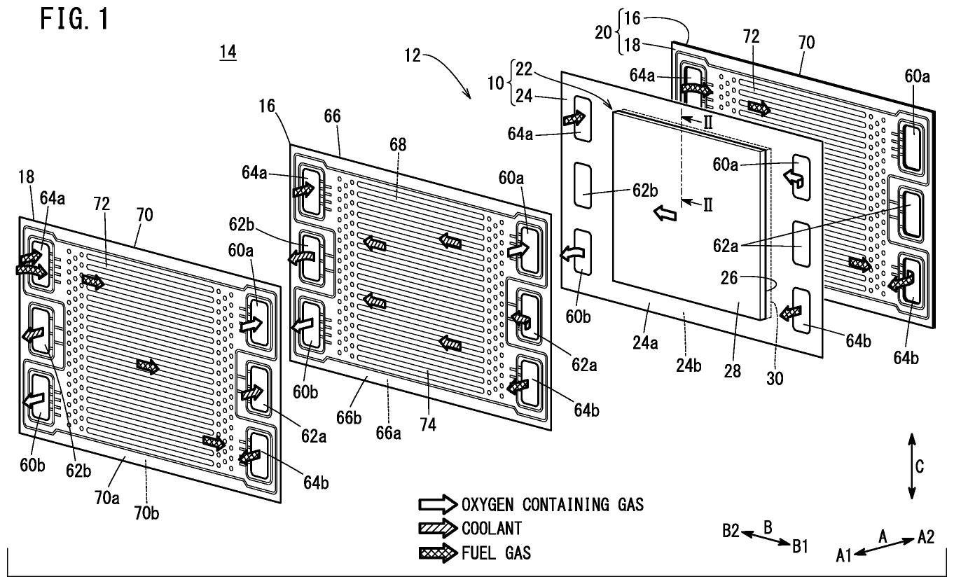

FIG. 1 is an exploded perspective view of an electrical power generating cell 12 provided with a resin frame equipped MEA 10 according to a first embodiment. The electrical power generating cell 12 is a unit cell of a fuel cell stack 14. The fuel cell stack 14 includes a plurality of electrical power generating cells 12 that are stacked on each other. The plurality of electrical power generating cells 12 are stacked in the direction of the arrow A. The fuel cell stack 14 is mounted, for example, as a vehicle incorporated fuel cell stack in a fuel cell electric vehicle (not shown).

The electrical power generating cell 12 includes a horizontally elongate rectangular shape. The electrical power generating cell 12 has the resin frame equipped MEA 10 (a resin frame equipped membrane electrode assembly), a first separator member 16, and a second separator member 18. The resin frame equipped MEA 10 is arranged between the first separator member 16 and the second separator member 18.

Each of the first separator member 16 and the second separator member 18 is formed, for example, by press-molding a cross section of a thin metal plate into a corrugated shape. The thin metal plate, for example, is a steel plate, a stainless steel plate, an aluminum plate, or a plated steel plate. The thin metal plate may be a stainless steel plate on which an anti-corrosive surface treatment has been performed, or an aluminum plate on which an anti-corrosive surface treatment has been performed. The first separator member 16 and the second separator member 18 are joined to each other by a plurality of non-illustrated joining lines, and thereby form a joined separator 20.

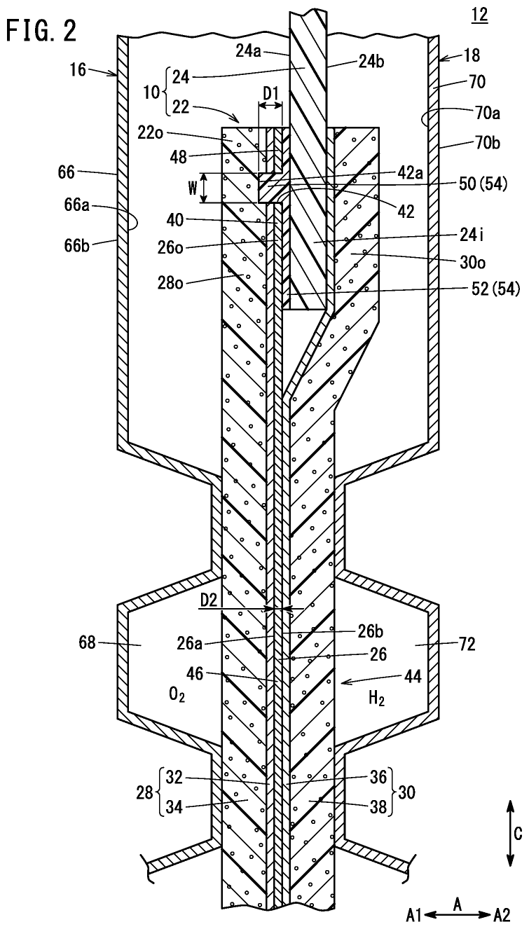

As shown in FIGS. 1 and 2, the resin frame equipped MEA 10 comprises an MEA 22 (membrane electrode assembly) and a resin frame member 24. The resin frame member 24 is attached to an outer peripheral portion 22o so as to project outwardly from the outer peripheral portion 22o of the MEA 22.

As shown in FIG. 2, the MEA 22 includes an electrolyte membrane 26, a first electrode 28, and a second electrode 30. The first electrode 28, for example, is an anode. The second electrode 30, for example, is a cathode. Conversely thereto, the first electrode 28 may be used as a cathode, and the second electrode 30 may be used as an anode.

The first electrode 28 is arranged on a first surface 26a of the electrolyte membrane 26. The second electrode 30 is arranged on a second surface 26b of the electrolyte membrane 26. The electrolyte membrane 26 is a solid polymer electrolyte membrane (cation ion exchange membrane). The solid polymer electrolyte membrane is formed by impregnating a thin membrane of perfluorosulfonic acid with water, for example. The electrolyte membrane 26 is sandwiched and gripped between the first electrode 28 and the second electrode 30. The electrolyte membrane 26 may be a fluorine based electrolyte or an HC (hydrocarbon) based electrolyte.

The first electrode 28 includes a first electrode catalyst layer 32 and a first gas diffusion layer 34. The first electrode catalyst layer 32 is joined to the first surface 26a of the electrolyte membrane 26. The first gas diffusion layer 34 is stacked on the first electrode catalyst layer 32. The second electrode 30 includes a second electrode catalyst layer 36 and a second gas diffusion layer 38. The second electrode catalyst layer 36 is joined to the second surface 26b of the electrolyte membrane 26. The second gas diffusion layer 38 is stacked on the second electrode catalyst layer 36.

The first electrode catalyst layer 32 contains, for example, porous carbon particles on which a platinum alloy is supported on surfaces thereof. The porous carbon particles are physically bonded to each other through an ion conductive polymer binder. In this state, the porous carbon particles are uniformly coated on a surface of the first gas diffusion layer 34. The second electrode catalyst layer 36 contains, for example, porous carbon particles on which a platinum alloy is supported on surfaces thereof. The porous carbon particles are physically bonded to each other through an ion conductive polymer binder. In this state, the porous carbon particles are uniformly coated on a surface of the second gas diffusion layer 38. The first gas diffusion layer 34 and the second gas diffusion layer 38 include carbon paper, carbon cloth, or the like.

The resin frame member 24 possesses an electrical insulating property. As examples of the material of the resin frame member 24, there may be cited PPS (polyphenylene sulfide), PPA (polyphthalamide), PEN (polyethylene naphtalate), PES (polyethersulfone), LCP (liquid crystal polymer), PVDF (polyvinylidene fluoride), silicone resin, fluorosilicone resin, m-PPE (modified polyphenylene ether), PET (polyethylene terephtalate), PBT (polybutylene terephthalate), or modified polyolefin and the like.

The resin frame member 24 is a rectangular annular shaped member (refer to FIG. 1). An inner peripheral portion 24i of the resin frame member 24 is arranged between an outer peripheral portion 28o of the first electrode 28 and an outer peripheral portion 30o of the second electrode 30. More specifically, the inner peripheral portion 24i of the resin frame member 24 is sandwiched between an outer peripheral portion 26o of the electrolyte membrane 26 and the outer peripheral portion 30o of the second electrode 30. The first surface 24a of the resin frame member 24 faces toward the outer peripheral portion 26o of the electrolyte membrane 26. The second surface 24b of the resin frame member 24 faces toward the outer peripheral portion 30o of the second electrode 30. Moreover, the inner peripheral portion 24i of the resin frame member 24 may be sandwiched between the outer peripheral portion 26o of the electrolyte membrane 26 and the outer peripheral portion 28o of the first electrode 28.

The outer peripheral portion 26o of the electrolyte membrane 26 includes an outer peripheral overlapping portion 40 that overlaps with the inner peripheral portion 24i of the resin frame member 24. The outer peripheral overlapping portion 40 extends in an annular shape (a rectangular annular shape) along the inner peripheral portion 24i of the resin frame member 24. The outer peripheral portion 22o of the MEA 22 includes a groove 42 therein that penetrates in a thickness direction (the direction of the arrow A) through the outer peripheral overlapping portion 40 of the electrolyte membrane 26.

The groove 42 surrounds an electrical power generating region 44 of the MEA 22. Stated otherwise, the groove 42 extends in an annular shape (a rectangular annular shape) along the outer periphery of the electrolyte membrane 26. In particular, the groove 42 separates the electrolyte membrane 26 into a central region 46 (a portion forming the electrical power generating region 44 of the MEA 22) and an outer peripheral end portion 48. The electrical power generating region 44 refers to a region of the MEA 22 in which the first electrode 28 is in contact with the first surface 26a of the electrolyte membrane 26, and further, the second electrode 30 is in contact with the second surface 26b of the electrolyte membrane 26.

The groove 42 opens on the second surface 26b of the electrolyte membrane 26. A bottom part 42a of the groove 42 is positioned in the interior of the first gas diffusion layer 34. More specifically, the groove 42 penetrates in the thickness direction through the electrolyte membrane 26 and the first electrode catalyst layer 32. Stated otherwise, a depth D1 of the groove 42 is greater than a thickness D2 of the electrolyte membrane 26. A width W of the groove 42 is greater than the thickness D2 of the electrolyte membrane 26.

However, the depth D1 and the width W of the groove 42 can be appropriately set. In particular, the bottom part 42a of the groove 42 may be positioned at a boundary between the first electrode catalyst layer 32 and the first gas diffusion layer 34. Further, the bottom part 42a of the groove 42 may be positioned in the interior of the first electrode catalyst layer 32. Furthermore, the bottom part 42a of the groove 42 may be positioned at a boundary between the electrolyte membrane 26 and the first electrode catalyst layer 32. The groove 42 needs only to at least penetrate through the electrolyte membrane 26.

A resin-fabricated first ion flow blocking member 50 for blocking the flow of ions (for example, metallic ions such as iron ions or the like) is positioned in the groove 42. More specifically, in the first embodiment, the first ion flow blocking member 50 is provided as a tangible object in the groove 42 of the outer peripheral overlapping portion 40 of the electrolyte membrane 26. In this manner, the first ion flow blocking member 50 serves as a physical barrier.

In this case, the first ion flow blocking member 50 is integrally connected to a resin-fabricated adhesive layer 52. The adhesive layer 52 joins the outer peripheral overlapping portion 40 of the electrolyte membrane 26 and the inner peripheral portion 24i of the resin frame member 24 to each other. In particular, the first ion flow blocking member 50 is formed by filling the groove 42 with an adhesive 54 that forms the adhesive layer 52, and then curing the adhesive layer 52. The first ion flow blocking member 50 may be separated from the adhesive layer 52 without being integrally connected thereto. Further, the resin material and the adhesive 54 constituting the first ion flow blocking member 50 may be different materials from each other. Furthermore, the material of the first ion flow blocking member 50 may be an inorganic material.

The adhesive 54 may be either a liquid or a solid. Further, the adhesive 54 may be a thermosetting resin or a thermoplastic resin. More specifically, as examples of the resin material used as the adhesive 54 (the resin material forming the first ion flow blocking member 50), there may be cited silicone resin-based, fluororesin-based, and epoxy resin-based adhesives.

In such a resin frame equipped MEA 10, the first surface 24a of the resin frame member 24 is joined to the outer peripheral overlapping portion 40 of the electrolyte membrane 26 through the adhesive layer 52. The second surface 24b of the resin frame member 24 abuts against (is in contact with) the outer peripheral portion 30o of the second electrode 30.

As shown in FIG. 1, one end edge portion in the direction of the longitudinal sides of each of the electrical power generating cells 12 includes an oxygen containing gas supply passage 60a, a coolant supply passage 62a, and a fuel gas discharge passage 64b. The one end edge portion in the direction of the longitudinal sides of each of the electrical power generating cells 12 is an end edge portion in the direction of the arrow B1 of each of the electrical power generating cells 12. The oxygen containing gas supply passage 60a, the coolant supply passage 62a, and the fuel gas discharge passage 64b are disposed by being arranged alongside one another in the direction of the lateral sides of each of the electrical power generating cells 12. The direction of the lateral sides of each of the electrical power generating cells 12 lies along the direction of the arrow C.

An oxidizing gas (for example, an oxygen containing gas), which is one reaction gas, flows through the oxygen containing gas supply passage 60a toward the direction of the arrow A2. A coolant (for example, pure water, ethylene glycol, or oil) flows through the coolant supply passage 62a toward the direction of the arrow A2. A fuel gas (for example, a hydrogen containing gas), which is another reaction gas, flows through the fuel gas discharge passage 64b toward the direction of the arrow A1.

Another end edge portion in the direction of the longitudinal sides of each of the electrical power generating cells 12 includes a fuel gas supply passage 64a, a coolant discharge passage 62b, and an oxygen containing gas discharge passage 60b. The other end edge portion in the direction of the longitudinal sides of each of the electrical power generating cells 12 is an end edge portion in the direction of the arrow B2 of each of the electrical power generating cells 12. The fuel gas supply passage 64a, the coolant discharge passage 62b, and the oxygen containing gas discharge passage 60b are arranged alongside one another in the direction of the arrow C.

The fuel gas flows through the fuel gas supply passage 64a toward the direction of the arrow A2. The coolant flows through the coolant discharge passage 62b toward the direction of the arrow A1. The oxygen containing gas flows through the oxygen containing gas discharge passage 60b toward the direction of the arrow A1.

The number, the arrangement, the shape, and the size of the aforementioned passages (the oxygen containing gas supply passage 60a and the like) are not limited to those of the illustrated example. The number, the arrangement, the shape, and the size of the aforementioned passages (the oxygen containing gas supply passage 60a and the like) may be appropriately set in accordance with specifications required by the fuel cell stack 14.

As shown in FIGS. 1 and 2, the first separator member 16 is equipped with a metal plate-shaped first separator main body 66. The first separator main body 66 has a rectangular shape. On a surface 66a of the first separator main body 66 facing toward the resin frame equipped MEA 10, an oxygen containing gas flow field 68 (reaction gas flow field), which extends in the direction of the longitudinal sides (the direction of the arrow B) of the electrical power generating cells 12, is formed by press molding. The oxygen containing gas flow field 68 communicates fluidically with the oxygen containing gas supply passage 60a and the oxygen containing gas discharge passage 60b. The oxygen containing gas flow field 68 supplies the oxygen containing gas to the first electrode 28.

The second separator member 18 is equipped with a metal plate-shaped second separator main body 70. The second separator main body 70 has a rectangular shape. On a surface 70a of the second separator main body 70 facing toward the resin frame equipped MEA 10, a fuel gas flow field 72 (reaction gas flow field), which extends in the direction of the longitudinal sides (the direction of the arrow B) of the electrical power generating cells 12, is formed by press molding. The fuel gas flow field 72 communicates fluidically with the fuel gas supply passage 64a and the fuel gas discharge passage 64b. The fuel gas flow field 72 supplies the fuel gas to the second electrode 30.

As shown in FIG. 1, a coolant flow field 74 is positioned between a surface 66b of the first separator main body 66 and a surface 70b of the second separator main body 70 that are joined to each other. The coolant flow field 74 communicates fluidically with the coolant supply passage 62a and the coolant discharge passage 62b. The coolant flow field 74 is formed by overlapping and matching together the rear surface shape of the first separator main body 66 on which the oxygen containing gas flow field 68 is formed, and the rear surface shape of the second separator main body 70 on which the fuel gas flow field 72 is formed.

The electrical power generating cells 12, which are configured in the manner described above, operate in the following manner.

First, as shown in FIG. 1, an oxygen containing gas is supplied to the oxygen containing gas supply passage 60a. The fuel gas is supplied to the fuel gas supply passage 64a. The coolant is supplied to the coolant supply passage 62a.

The oxygen containing gas is introduced from the oxygen containing gas supply passage 60a into the oxygen containing gas flow field 68 of the first separator member 16. Thereafter, the oxygen containing gas moves along the oxygen containing gas flow field 68 in the direction of the arrow B2, and is supplied to the first electrode 28 of the MEA 22.

On the other hand, as shown in FIG. 1, the fuel gas is introduced from the fuel gas supply passage 64a into the fuel gas flow field 72 of the second separator member 18. In addition, the fuel gas moves in the direction of the arrow B1 along the fuel gas flow field 72, and is supplied to the second electrode 30 of the MEA 22.

Accordingly, in each of the MEAs 22, the oxygen containing gas supplied to the first electrode 28 and the fuel gas supplied to the second electrode 30 are consumed by electrochemical reactions in the first electrode catalyst layer 32 and the second electrode catalyst layer 36. As a result, generation of electrical power is carried out.

Next, as shown in FIG. 1, the oxygen containing gas which is supplied to and consumed by the first electrode 28 flows from the oxygen containing gas flow field 68 to the oxygen containing gas discharge passage 60b. Thereafter, the oxygen containing gas is discharged in the direction of the arrow A1 along the oxygen containing gas discharge passage 60b. Similarly, the fuel gas which is supplied to and consumed by the second electrode 30 flows from the fuel gas flow field 72 to the fuel gas discharge passage 64b. Thereafter, the fuel gas is discharged in the direction of the arrow A1 along the fuel gas discharge passage 64b.

In order to keep the electrolyte membrane 26 in a humidified state, water vapor is added to the fuel gas and the oxygen containing gas. Accordingly, the fuel gas and the oxygen containing gas are kept relatively humid.

The coolant supplied to the coolant supply passage 62a is introduced into the coolant flow field 74 that is formed between the first separator main body 66 and the second separator main body 70. The coolant is introduced into the coolant flow field 74, and thereafter, flows in the direction of the arrow B2. After having cooled the MEA 22, the coolant is discharged from the coolant discharge passage 62b.

Next, a description will be given concerning a method of manufacturing the resin frame equipped MEA 10 according to the first embodiment.

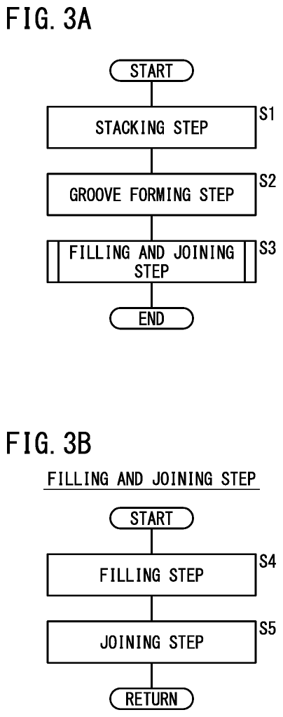

As shown in FIG. 3A, the method for manufacturing the resin frame equipped MEA 10 according to the first embodiment includes a stacking step, a groove forming step, and a filling and joining step. As will be discussed later, a joining step is included in the filling and joining step.

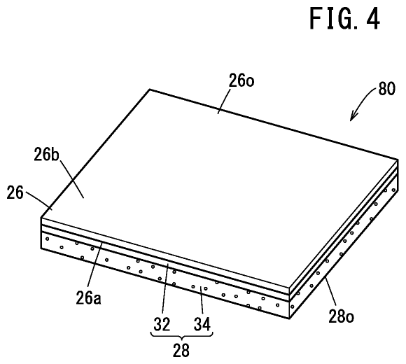

In the stacking step (step S1), as shown in FIG. 4, a stacked body 80 is obtained by stacking the electrolyte membrane 26 on the first electrode 28. The electrolyte membrane 26 has a planar dimension (external dimension) of the same size as that of the first electrode 28. Moreover, in the stacking step, the first electrode 28 and the electrolyte membrane 26 are joined to each other by hot pressing. More specifically, a load is applied while being heated in a state in which the electrolyte membrane 26 is stacked on the first electrode 28.

In the stacked body 80 that was obtained in the stacking step, the first surface 26a of the electrolyte membrane 26 is placed in contact with the first electrode catalyst layer 32. In the stacked body 80, the second surface 26b of the electrolyte membrane 26 is exposed.

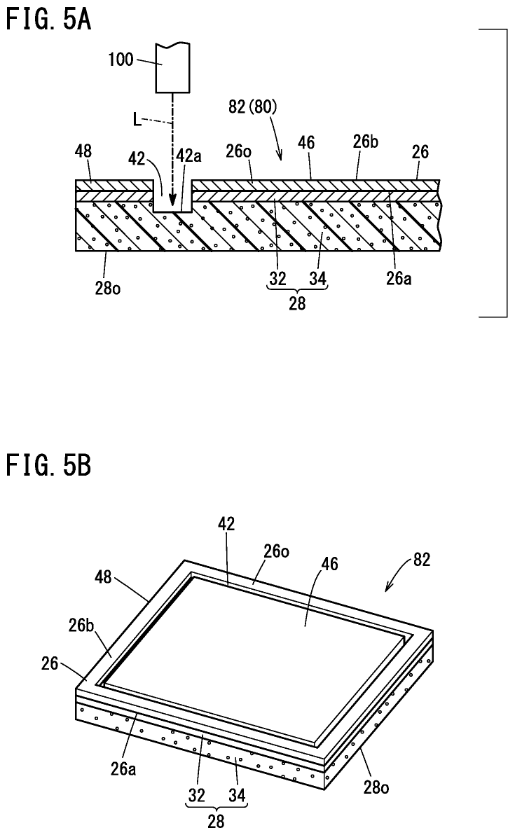

Subsequently, in the groove forming step (step S2 of FIG. 3A), as shown in FIG. 5A, the stacked body 80 is laser machined to thereby form a machined stacked body 82. More specifically, in the groove forming step, a laser machining apparatus 100 irradiates the outer peripheral portion 26o of the electrolyte membrane 26 (the second surface 26b of the electrolyte membrane 26) with a laser beam L used for machining. Subsequently, the laser beam L is made to encircle (go around) along the outer periphery of the electrolyte membrane 26. Consequently, a continuous rectangular annular groove 42 is formed on the outer peripheral portion 26o of the electrolyte membrane 26 along the outer periphery of the electrolyte membrane 26 (refer to FIG. 5B).

The method of forming the groove 42 is not limited to the aforementioned laser machining. In the groove forming step, the groove 42 may be formed by machining the outer peripheral portion 26o of the electrolyte membrane 26 (the second surface 26b of the electrolyte membrane 26) with a cutter. Further, in the groove forming step, the groove 42 may be formed by coating a chemical substance on the outer peripheral portion 26o of the electrolyte membrane 26 (the second surface 26b of the electrolyte membrane 26) to thereby cause the electrolyte membrane 26 to undergo melting.

Thereafter, in the filling and joining step (step S3 of FIG. 3A), the groove 42 is filled with a resin material that forms the first ion flow blocking member 50 for blocking the flow of ions, and the inner peripheral portion 24i of the resin frame member 24 is joined to the outer peripheral portion 22o of the MEA 22. At this time, the groove 42 is covered by the inner peripheral portion 24i of the resin frame member 24, and the inner peripheral portion 24i of the resin frame member 24 overlaps with the outer peripheral portion 26o of the electrolyte membrane 26.

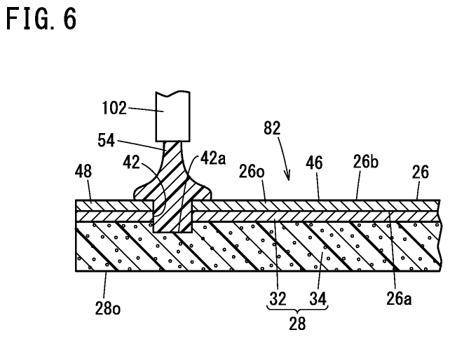

More specifically, as shown in FIG. 3B, the filling and joining step includes a filling step and a joining step. In the filling step (step S4), as shown in FIG. 6, the adhesive 54 (a resin material) which is supplied from a dispenser 102 is filled in the groove 42. At this time, the adhesive 54 is also coated on the outer surface of the outer peripheral portion 26o of the electrolyte membrane 26 (the second surface 26b of the electrolyte membrane 26).

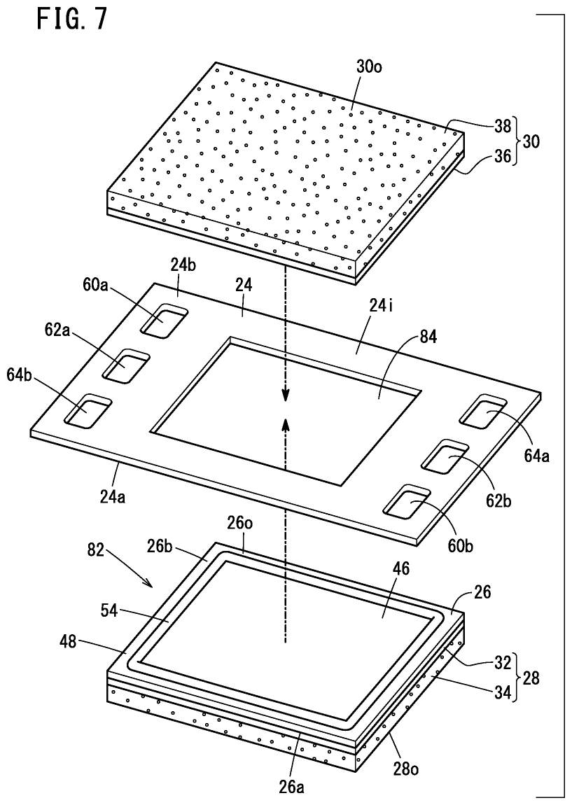

In the joining step (step S5 of FIG. 3B), as shown in FIG. 7, the machined stacked body 82 obtained by the groove forming step, the resin frame member 24, and the second electrode 30 are prepared. Moreover, one end edge portion of the resin frame member 24 includes the oxygen containing gas supply passage 60a, the coolant supply passage 62a, and the fuel gas discharge passage 64b. Another end edge portion of the resin frame member 24 includes the fuel gas supply passage 64a, the coolant discharge passage 62b, and the oxygen containing gas discharge passage 60b. A central portion of the resin frame member 24 includes an opening 84 therein.

Thereafter, the inner peripheral portion 24i of the resin frame member 24 is arranged between the outer peripheral portion 26o of the electrolyte membrane 26 and the outer peripheral portion 30o of the second electrode 30, and the members are joined together. Such joining is performed, for example, by hot pressing. More specifically, the first electrode 28, the electrolyte membrane 26, the resin frame member 24, and the second electrode 30, which are stacked in the thickness direction, are heated and a load is applied thereto.

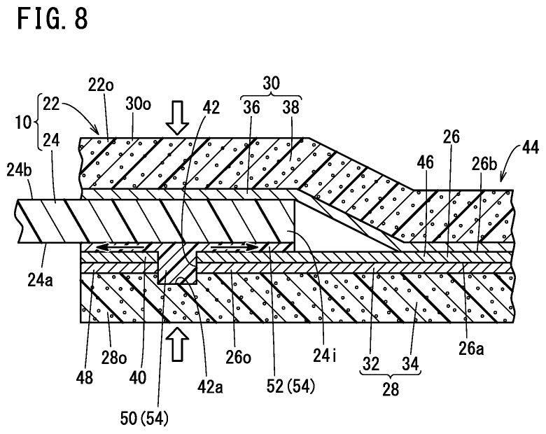

Consequently, as shown in FIG. 8, the second surface 26b of the electrolyte membrane 26 and the second electrode 30 are joined to each other to thereby form the MEA 22. Further, on the outer peripheral portion 26o of the electrolyte membrane 26, the outer peripheral overlapping portion 40 is formed which overlaps with the inner peripheral portion 24i of the resin frame member 24.

Furthermore, because the adhesive 54 is sandwiched between the outer peripheral portion 26o of the electrolyte membrane 26 and the inner peripheral portion 24i of the resin frame member 24, the adhesive 54 flows toward an outer direction of the electrolyte membrane 26, and furthermore, flows toward an inner direction (the central region 46) of the electrolyte membrane 26. Thereafter, by the adhesive 54 becoming cured and hardened, the adhesive layer 52 is formed between the outer peripheral overlapping portion 40 of the electrolyte membrane 26 and the inner peripheral portion 24i of the resin frame member 24. Further, the adhesive 54 that is filled in the groove 42 is also cured. As a result, the first ion flow blocking member 50 is formed. Consequently, the resin frame equipped MEA 10 is formed. When the joining step is completed, the series of operation flows of the method of manufacturing the resin frame equipped MEA 10 comes to an end.

In the above-described fuel cell stack 14, ions may be generated from the members that constitute the fuel cell stack 14. There is a possibility that such ions may enter into the space in which the outer peripheral portion of the MEA 22 is arranged. The aforementioned ions, for example, are metallic ions such as iron ions (Fe²⁺) or copper ions (Cu²⁺) which are generated from the first separator member 16 and the second separator member 18. The metal ions of this type are generated due to elution of the metal components of the first separator member 16 and the second separator member 18 by the water vapor contained within the reaction gases.

The first embodiment exhibits the following advantageous effects.

The outer peripheral portion 22o of the MEA 22 includes the groove 42 that penetrates in the thickness direction through the outer peripheral overlapping portion 40. The first ion flow blocking member 50 for blocking the flow of ions is positioned in the groove 42. More specifically, the first ion flow blocking member 50 is disposed on the outer peripheral overlapping portion 40 of the electrolyte membrane 26.

In accordance with such a configuration, the first ion flow blocking member 50 is positioned on the outer peripheral overlapping portion 40 of the electrolyte membrane 26. Accordingly, it is possible to suppress the entry of iron ions, copper ions, or the like from the outer peripheral end into the central region 46 (the portion forming the electrical power generating region 44 of the MEA 22) of the electrolyte membrane 26. Consequently, it is possible to prevent the central region 46 of the electrolyte membrane 26 from suffering from deterioration due to ingress of ions from an outer peripheral side of the MEA 22.

The groove 42 and the first ion flow blocking member 50 surround the electrical power generating region 44 of the MEA 22.

In accordance with such a configuration, the ingress of ions from the outer peripheral edge of the electrolyte membrane 26 into the central region 46 can be effectively suppressed.

The inner peripheral portion 24i of the resin frame member 24 is sandwiched between the outer peripheral portion 28o of the first electrode 28 and the outer peripheral portion 30o of the second electrode 30.

In accordance with such a configuration, the outer peripheral portion 26o of the electrolyte membrane 26 can be effectively covered by the resin frame member 24 and the outer peripheral portion 30o of the second electrode 30. Therefore, it is possible to prevent the ions from being guided to the electrolyte membrane 26 from the outer peripheral portion 30o of the second electrode 30.

The first surface 24a of the resin frame member 24 is joined to the outer peripheral overlapping portion 40 of the electrolyte membrane 26. The second surface 24b of the resin frame member 24 is joined with respect to the outer peripheral portion 30o of the second electrode 30.

In accordance with such a configuration, it is possible to prevent the ions from flowing inwardly between the first surface 24a of the resin frame member 24 and the outer peripheral overlapping portion 40 of the electrolyte membrane 26. Further, it is possible to prevent the ions from flowing inwardly between the second surface 24b of the resin frame member 24 and the outer peripheral portion 30o of the second electrode 30.

The material forming the first ion flow blocking member 50 is the adhesive 54, which joins the inner peripheral portion 24i of the resin frame member 24 and the outer peripheral overlapping portion 40 of the electrolyte membrane 26 to each other.

In accordance with such a configuration, since the first ion flow blocking member 50 can be formed by filling the groove 42 with the adhesive 54, the process of manufacturing the resin frame equipped MEA 10 can be simplified.

The outer peripheral portion 28o of the first electrode 28 overlaps with the outer peripheral overlapping portion 40 of the electrolyte membrane 26. The groove 42 is formed on the outer peripheral overlapping portion 40 of the electrolyte membrane 26 and the outer peripheral portion 28o of the first electrode 28.

In accordance with such a configuration, the ingress of ions from the outer peripheral edge of the electrolyte membrane 26 into the central region 46 can be effectively suppressed.

The method for manufacturing the resin frame equipped MEA 10 includes the stacking step, the groove forming step, and the filling and joining step. In the stacking step, the stacked body 80 is obtained by stacking the electrolyte membrane 26 on the first electrode 28. In the groove forming step, after the stacking step, the groove 42, which penetrates in the thickness direction through the outer peripheral portion 26o of the electrolyte membrane 26, is formed on the outer peripheral portion of the stacked body 80. In the filling and joining step, the groove 42 is filled with the resin material that forms the first ion flow blocking member 50 for blocking the flow of ions. In this state, the inner peripheral portion 24i of the resin frame member 24 is joined to the outer peripheral portion 22o of the MEA 22, in a manner so that the inner peripheral portion 24i of the resin frame member 24 overlaps with the outer peripheral portion 26o of the electrolyte membrane 26. Further, in the filling and joining step, the outer peripheral overlapping portion 40, which overlaps with the inner peripheral portion 24i of the resin frame member 24, is formed on the outer peripheral portion 26o of the electrolyte membrane 26, and the groove 42 is positioned on the outer peripheral overlapping portion 40.

In accordance with such a method, it is possible to easily manufacture the resin frame equipped MEA 10 which is capable of suppressing the ingress of ions from the outer peripheral end of the electrolyte membrane 26 into the central region 46 (the portion that forms the electrical power generating region 44 of the MEA 22).

In the groove forming step, the groove 42 is formed on the outer peripheral portion 26o of the electrolyte membrane 26, in a matter so that the groove 42 extends in an annular shape along the outer peripheral portion of the electrolyte membrane 26.

In accordance with such a method, the ingress of ions from the outer peripheral edge of the electrolyte membrane 26 into the central region 46 can be effectively suppressed.

In the groove forming step, the groove 42 is formed by laser machining on the outer peripheral portion 26o of the electrolyte membrane 26.

In accordance with such a method, the groove 42 can be easily formed in the outer peripheral portion 26o of the electrolyte membrane 26.

The filling and joining step includes the filling step and the joining step. In the filling step, the adhesive 54 is filled in the groove 42. In the joining step, after the filling step, the resin frame member 24 is joined to the outer peripheral portion 22o of the MEA 22 by sandwiching the adhesive 54 between the outer peripheral overlapping portion 40 of the electrolyte membrane 26 and the inner peripheral portion 24i of the resin frame member 24.

In accordance with such a method, in the filling step, the adhesive 54 can be easily and reliably filled in the groove 42.

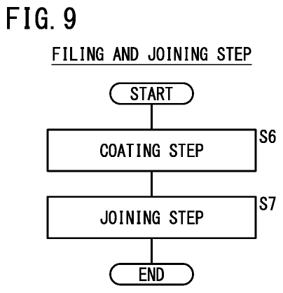

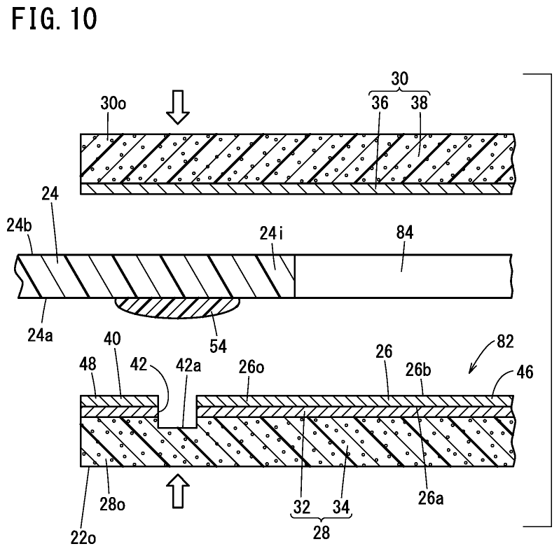

The method of manufacturing the resin frame equipped MEA 10 according to the first embodiment is not limited to the method described above. As shown in FIG. 9, the filling and joining step may include a coating step and a joining step. In this case, in the coating step (step S6), as shown in FIG. 10, the adhesive 54 which is in a liquid state is coated on an inner peripheral portion of the first surface 24a of the resin frame member 24.

In the joining step (step S7 of FIG. 9), after the coating step, the adhesive 54 is sandwiched between the outer peripheral overlapping portion 40 of the electrolyte membrane 26 and the inner peripheral portion 24i of the resin frame member 24. Consequently, the adhesive 54 (flows into and) is filled in the groove 42, and the inner peripheral portion 24i of the resin frame member 24 is joined to the outer peripheral portion 22o of the MEA 22. In accordance with such a method as well, it is possible to manufacture the above-described resin frame equipped MEA 10.

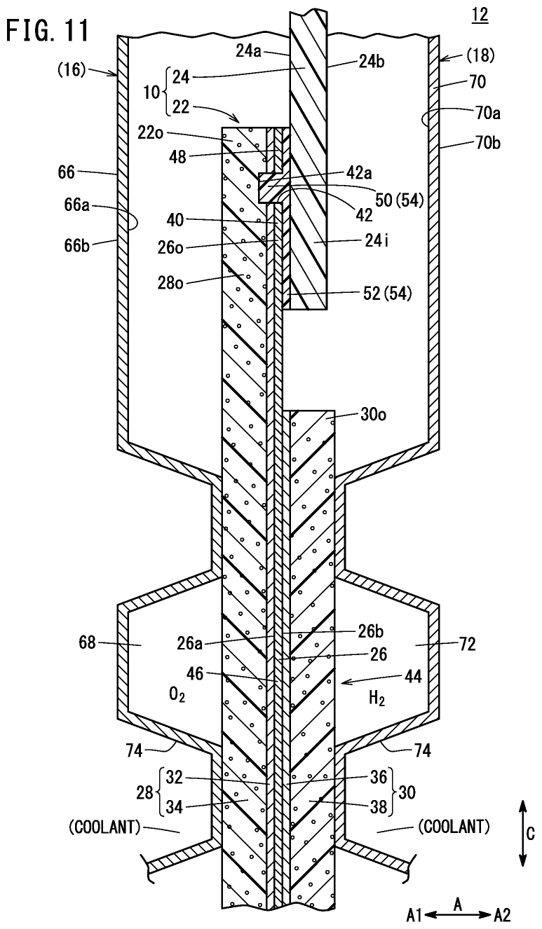

As shown in FIG. 11, in the resin frame equipped MEA 10, the outer peripheral end of the second electrode 30 may be positioned more inwardly than the inner peripheral end of the resin frame member 24. More specifically, the inner peripheral portion 24i of the resin frame member 24 may be not sandwiched between the outer peripheral portion 28o of the first electrode 28 and the outer peripheral portion 30o of the second electrode 30.

Next, a description will be given concerning a second embodiment. The configurations of constituent elements thereof, which are not described in particular below, are the same configurations as those elements that were described in the first embodiment. Accordingly, unless otherwise specified, the same names and the same reference numerals shown in the first embodiment will be applied correspondingly to each of such elements.

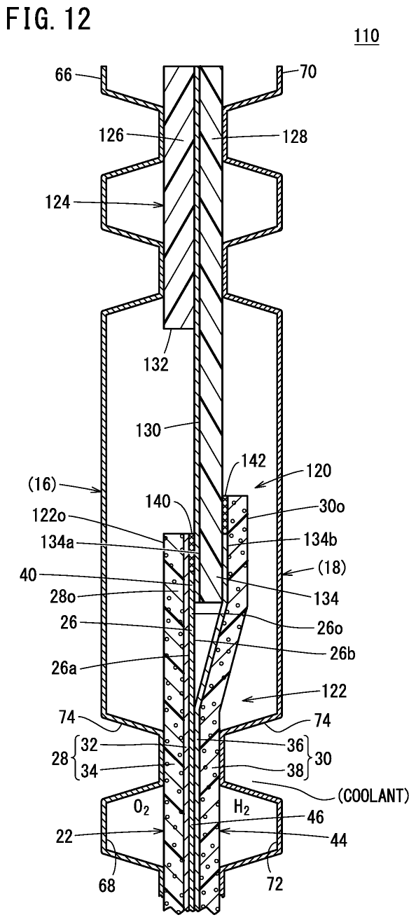

FIG. 12 is a vertical cross-sectional view of principal components of an electrical power generating cell 110. The electrical power generating cell 110 includes a resin frame equipped MEA 120 according to the second embodiment. The resin frame equipped MEA 120 comprises an MEA 122 (membrane electrode assembly) and a resin frame member 124. The resin frame member 124 is attached to an outer peripheral portion 122o so as to project outwardly from the outer peripheral portion 122o of the MEA 122.

In this case, the resin frame member 124 includes a frame-shaped first sheet 126 and a frame-shaped second sheet 128. An adhesive layer 130 is interposed between the first sheet 126 and the second sheet 128. The first sheet 126 and the second sheet 128 are joined and stacked via the adhesive layer 130. As examples of the material used for the first sheet 126 and the second sheet 128, there may be cited the same resin materials as the materials of the resin frame member 24 according to the first embodiment.

The external dimension of the second sheet 128 is larger than the external dimension of the first sheet 126. Therefore, a portion of the second sheet 128 projects more toward the MEA 122 than an inner peripheral end 132 of the first sheet 126 does. Hereinafter, such a portion will be referred to as an “inner peripheral portion 134”. The inner peripheral portion 134 includes a first surface 134a facing toward the electrolyte membrane 26, and a second surface 134b facing toward the second electrode 30. The adhesive layer 130 is provided over the entire surface of the second sheet 128 that faces toward the first sheet 126. Accordingly, the adhesive layer 130 is also provided on the first surface 134a of the inner peripheral portion 134.

The outer peripheral overlapping portion 40 of the outer peripheral portion 26o of the electrolyte membrane 26 overlaps with the first surface 134a of the inner peripheral portion 134 of the second sheet 128. Since the adhesive layer 130 is disposed on the inner peripheral portion 134, the inner peripheral portion 134 and the outer peripheral overlapping portion 40 are joined via the adhesive layer 130. The outer peripheral portion 30o of the second electrode 30 is overlapped with the second surface 134b of the inner peripheral portion 134 of the second sheet 128. More specifically, the second electrode catalyst layer 36 of the second electrode 30 is placed in contact with the second surface 134b. Moreover, the first sheet 126 is not in contact with the MEA 122.

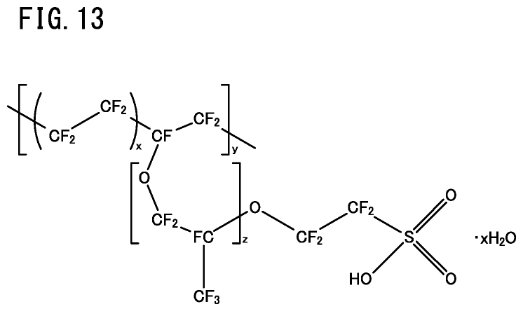

In the second embodiment, the electrolyte membrane 26 is made up from a thin membrane of a solid polymer having a functional group. As a preferred specific example of the solid polymer having such a functional group, there may be cited perfluorosulfonic acid. FIG. 13 shows a chemical structural formula of perfluorosulfonic acid. In this case, the functional group is a sulfonic acid group (—SO₃H). The sulfonic acid group is a hydrophilic group.

In the same manner as in the first embodiment, the first electrode catalyst layer 32 and the second electrode catalyst layer 36 include an ion conductive polymer binder that physically binds the porous carbon particles. A preferred specific example of the ion conductive polymer binder is perfluorosulfonic acid (refer to FIG. 13), in the same manner as the solid polymer of the electrolyte membrane 26.

A second ion flow blocking member 140 is provided in a rectangular annular shape (annular shape) on the outer peripheral overlapping portion 40 of the electrolyte membrane 26. A third ion flow blocking member 142 is provided in a rectangular annular shape (annular shape) on an outer edge portion of the second electrode catalyst layer 36. A description will now be given concerning the second ion flow blocking member 140 and the third ion flow blocking member 142.

The second ion flow blocking member 140 is a first altered section in which an outer edge portion of the electrolyte membrane 26 is chemically altered. Stated otherwise, the second ion flow blocking member 140 serves as a physical barrier. More specifically, in the case that the material of the electrolyte membrane 26 is perfluorosulfonic acid, then in the second ion flow blocking member 140, cations other than iron ions or copper ions are chemically bonded with respect to the sulfonic acid group. As suitable specific examples of the cations, there may be cited cesium ions (Cs⁺), lead ions (Pb²⁺), silver ions (Ag⁺), or alkaline earth metal ions. In the sulfonic acid group to which such cations are chemically bonded, the hydrophilicity thereof is lowered. Among the cations, alkaline earth metal ions are particularly preferable. In this case, the cost thereof is low and the cations can be easily obtained. Suitable specific examples of the alkaline earth metal ions are magnesium ions (Mg²⁺), calcium ions (Ca²⁺), strontium ions (Sr²⁺), and barium ions (Ba²⁺).

The third ion flow blocking member 142 is a second altered section in which the ion conductive polymer contained within the outer edge portion of the second electrode catalyst layer 36 is chemically altered. More specifically, the third ion flow blocking member 142 serves as a physical barrier. More specifically, in the case that the material of the ionic conductive polymer is perfluorosulfonic acid, then in the third ion flow blocking member 142, cations other than iron ions or copper ions are chemically bonded with respect to the sulfonic acid group in the same manner as described previously. Therefore, in the third ion flow blocking member 142 as well, the hydrophilicity thereof is lowered. Suitable specific examples of the cations, in the same manner as described previously, are cesium ions (Cs⁺), lead ions (Pb²⁺), silver ions (Ag⁺), magnesium ions (Mg²⁺), calcium ions (Ca²⁺), strontium ions (Sr²⁺), and barium ions (Ba²⁺).

The electrical power generating cell 110 operates in the same manner as the electrical power generating cell 12. The flow paths for the fuel gas, the oxygen containing gas, and the coolant are the same as those in the first embodiment (refer to FIG. 1). Therefore, detailed descriptions of the flow paths for the fuel gas, the oxygen containing gas, and the coolant will be omitted.

Next, a description will be given concerning a method of manufacturing the resin frame equipped MEA 120 according to the second embodiment.

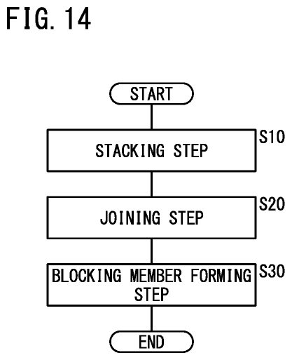

As shown in FIG. 14, the method of manufacturing the resin frame equipped MEA 120 according to the second embodiment includes a stacking step, a joining step, and a blocking member forming step.

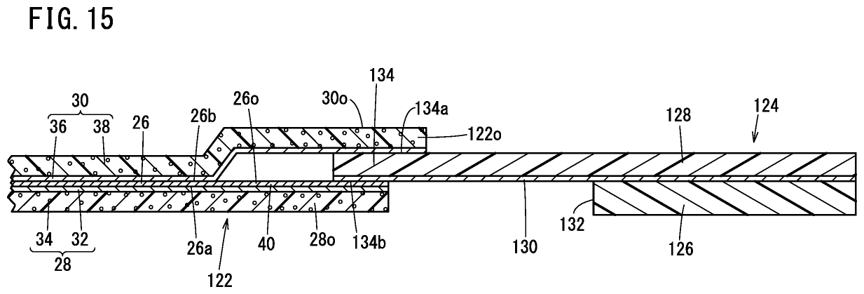

In the second embodiment, in the stacking step (step S10), as shown in FIG. 15, the electrolyte membrane 26 is stacked on the first electrode 28. At this time, the first electrode 28 is arranged on the first surface 26a of the electrolyte membrane 26. Thereafter, the second electrode 30 is stacked on the second surface 26b of the electrolyte membrane 26. The first electrode 28 may also be stacked on the first surface 26a of the electrolyte membrane 26 after the second electrode 30 has been stacked on the second surface 26b of the electrolyte membrane 26. By means of the foregoing process, the MEA 122 is obtained.

On the other hand, the first sheet 126 and the second sheet 128 are joined via the adhesive layer 130. Owing thereto, the resin frame member 124 is manufactured.

Next, as shown in FIG. 15, the inner peripheral portion 134 of the second sheet 128 is overlapped with the outer peripheral overlapping portion 40 of the electrolyte membrane 26. At this time, the first surface 134a of the second sheet 128 is oriented toward the outer peripheral overlapping portion 40. Since the adhesive layer 130 is disposed on the inner peripheral portion 134, the inner peripheral portion 134 and the outer peripheral overlapping portion 40 are joined via the adhesive layer 130.

Thereafter, the outer peripheral portion 30o of the second electrode 30 is overlapped with respect to the second surface 134b of the inner peripheral portion 134 of the second sheet 128. As a result, the second electrode catalyst layer 36 of the second electrode 30 is placed in contact with the second surface 134b.

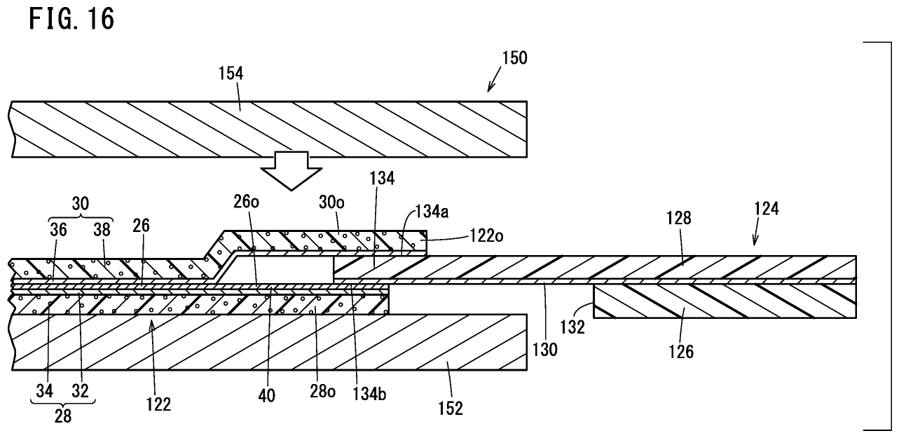

Next, a joining step (step S20) is carried out. In the joining step, a hot pressing device 150 as shown in FIG. 16 is used. The hot pressing device 150 comprises a pedestal 152 and a movable die 154. The movable die 154 can be displaced in a direction to approach toward or separate away from the pedestal 152.

The MEA 122 is placed on the pedestal 152 in a state with the inner peripheral portion 134 of the second sheet 128 sandwiched between the first electrode 28 and the second electrode 30. At this time, the first electrode 28 is oriented downward, and further, the second electrode 30 is oriented upward. Thereafter, the movable die 154, which is heated to a predetermined temperature, is lowered toward the pedestal 152. Due to such lowering, the outer peripheral portion of the MEA 122 and the inner peripheral portion 134 of the second sheet 128 are sandwiched between the pedestal 152 and the movable die 154. Accordingly, the outer peripheral portion of the MEA 122 and the inner peripheral portion 134 of the second sheet 128 are subjected to pressure. Since the movable die 154 is heated in the manner described above, the heat therefrom is applied to the outer peripheral portion of the MEA 122 and the inner peripheral portion 134 of the second sheet 128.

In the foregoing manner, hot pressing is carried out with respect to the outer peripheral portion of the MEA 122 and the inner peripheral portion 134 of the second sheet 128. As a result, the outer peripheral overlapping portion 40 of the electrolyte membrane 26 is joined to the inner peripheral portion 134 of the second sheet 128 via the adhesive layer 130. Consequently, the MEA 122 and the resin frame member 124 are joined together.

In the second embodiment, next, the blocking member forming step (step S30) is carried out. In this instance, an exemplary case will be described in which the second ion flow blocking member 140, which is the first altered section, and the third ion flow blocking member 142, which is the second altered section, are formed.

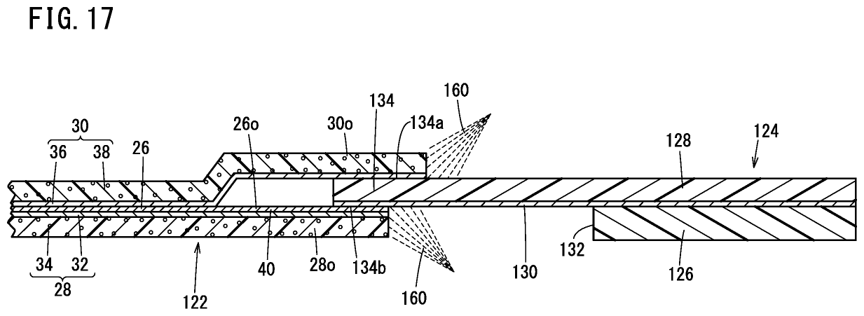

As shown in FIG. 17, in the blocking member forming step, a solution 160 containing the aforementioned cations is coated on a side surface of the outer edge portion of the outer peripheral overlapping portion 40 of the electrolyte membrane 26. Such coating, for example, is performed by way of spray coating. In this case, the solution 160 is sprayed on the side surface of the outer edge portion of the outer peripheral overlapping portion 40 of the electrolyte membrane 26. One preferred detailed example of the cations, as discussed previously, is barium ions. A suitable specific example of the solution 160 containing the barium ions is an aqueous solution of barium chloride (BaCl₂). However, the solvent of the solution 160 containing the barium ions is not limited to water. A barium salt, which is a source of barium ions, is not limited to barium chloride. Alternatively, a solution containing cesium ions, lead ions, silver ions, magnesium ions, calcium ions, or strontium ions may be used.

In the case that the material of the electrolyte membrane 26 is perfluorosulfonic acid, as shown in FIG. 13, the electrolyte membrane 26 includes a sulfonic acid group as a functional group. In the case that the cations are alkaline earth metal ions, it is presumed that the ions replace H⁺ of two sulfonic acid groups. In this case, the distance between the two sulfonic acid groups is narrowed. As a result, a portion of the electrolyte membrane 26 slightly contracts. Further, the above-described substitution lowers the hydrophilicity of the portion of the electrolyte membrane 26. As a result, the first altered section is formed on the portion of the electrolyte membrane 26. In the case that barium ions are used, the lowering of the hydrophilicity of the electrolyte membrane 26 is prominent.

The solution 160 is coated over the entire side surface of the outer edge portion of the outer peripheral overlapping portion 40 of the electrolyte membrane 26. Consequently, a rectangular annular first altered section (the second ion flow blocking member 140) is formed on the outer peripheral overlapping portion 40. Similarly, the solution 160 is applied over the entire side surface of the outer edge of the first electrode 28. The solution 160 can be adhered to the first electrode 28. In this case, the ionic conductive polymer, which is contained as the binder in the first electrode catalyst layer 32, is chemically altered. As a result, an ion flow blocking member in the form of a chemical barrier is formed on the first electrode catalyst layer 32.

Similarly, the solution 160 containing the aforementioned cations is coated on the side surface of the outer edge portion of the second electrode 30 (refer to FIG. 17). Such coating, for example, is performed by way of spray coating. A preferred detailed example of the cations, as discussed previously, is barium ions. Alternatively, a solution containing cesium ions, lead ions, silver ions, magnesium ions, calcium ions, or strontium ions may be used.

An ion conductive polymer binder is contained within the second electrode catalyst layer 36. In the case that the material of the ion conductive polymer binder is perfluorosulfonic acid, the cations are chemically bonded with the sulfonic acid group in the same manner as described previously. For example, H⁺ of two sulfonic acid groups is replaced by ions of the alkaline earth metal. In this case, the distance between the two sulfonic acid groups is narrowed. As a result, a portion of the second electrode catalyst layer 36 slightly contracts. Further, due to the above-described substitution, the hydrophilicity of the portion of the second electrode catalyst layer 36 is lowered. As a result, the second altered section is formed in the portion of the second electrode catalyst layer 36. In the case that barium ions are used, the lowering of the hydrophilicity of the second electrode catalyst layer 36 is prominent.

The solution 160 is applied over the entire side surface of the outer edge of the second electrode 30. Consequently, a rectangular annular second altered section (the third ion flow blocking member 142) is formed on the second electrode catalyst layer 36.

By means of the foregoing process, the resin frame equipped MEA 120, which includes the second ion flow blocking member 140 and the third ion flow blocking member 142, can be obtained. The second ion flow blocking member 140 and the third ion flow blocking member 142 exhibit a rectangular annular shape (annular shape). Based on the shape thereof, the second ion flow blocking member 140 and the third ion flow blocking member 142 surround the electrical power generating region 44 of the MEA 122.

The joining step and the blocking member forming step may be carried out in a reverse order. More specifically, it is also possible to perform the blocking member forming step first, and thereafter, to perform the joining step.

When the fuel cell stack 14 having the electrical power generating cell 110 is operated, in the same manner as in the first embodiment, water vapor is added to the fuel gas and the oxygen containing gas. In the case that the metal components of the first separator member 16 and the second separator member 18 become eluted by the water vapor contained within the reaction gases, metal ions such as iron ions (Fe²⁺) and copper ions (Cu²⁺) are generated.

The second embodiment exhibits the following advantageous effects.

The second ion flow blocking member 140 is disposed on the outer peripheral overlapping portion 40 of the electrolyte membrane 26. The third ion flow blocking member 142 is disposed on the outer peripheral portion of the second electrode catalyst layer 36.

The hydrophilicity of the second ion flow blocking member 140 and the third ion flow blocking member 142 is lowered. Therefore, in the second ion flow blocking member 140 and the third ion flow blocking member 142, a flow path for the moisture is reduced. Accordingly, it is difficult for the iron ions, the copper ions, or the like, which are eluted in the water vapor, to pass through the second ion flow blocking member 140 and the third ion flow blocking member 142.

Further, the aforementioned cations are strongly bonded to the sulfonic acid group. Therefore, it is difficult for the iron ions, the copper ions, or the like to replace the cations that are bonded to the sulfonic acid group. Accordingly, it is also difficult for the iron ions, the copper ions, or the like to move along the sulfonic acid group.

From the reasons described above, the iron ions, the copper ions, or the like are blocked by the second ion flow blocking member 140 and the third ion flow blocking member 142. Accordingly, it is possible to suppress the entry of the iron ions, the copper ions, or the like from the outer peripheral end into the central region 46 (in particular, the electrical power generating region 44 of the MEA 122) of the electrolyte membrane 26. Consequently, it is possible to prevent the central region 46 of the electrolyte membrane 26 from suffering from deterioration due to the influence of the iron ions, the copper ions, or the like.

The second ion flow blocking member 140 is a chemically altered section in the electrolyte membrane 26. The third ion flow blocking member 142 is a chemically altered section in the ion conductive polymer contained within the second electrode catalyst layer 36. In the case that the ion flow blocking member is provided in the form of a physical barrier, a machining step is required. In contrast thereto, since the second ion flow blocking member 140 and the third ion flow blocking member 142 serve as chemical barriers, it is unnecessary for a machining step to be performed in order to provide the second ion flow blocking member 140 and the third ion flow blocking member 142.

In order to cause the electrolyte membrane 26 and the like to be chemically altered, for example, the solution 160 containing cations such as alkaline earth metal ions or the like is coated on the electrolyte membrane 26. Consequently, the first altered section (the second ion flow blocking member 140) and the second altered section (the third ion flow blocking member 142) can be easily formed.

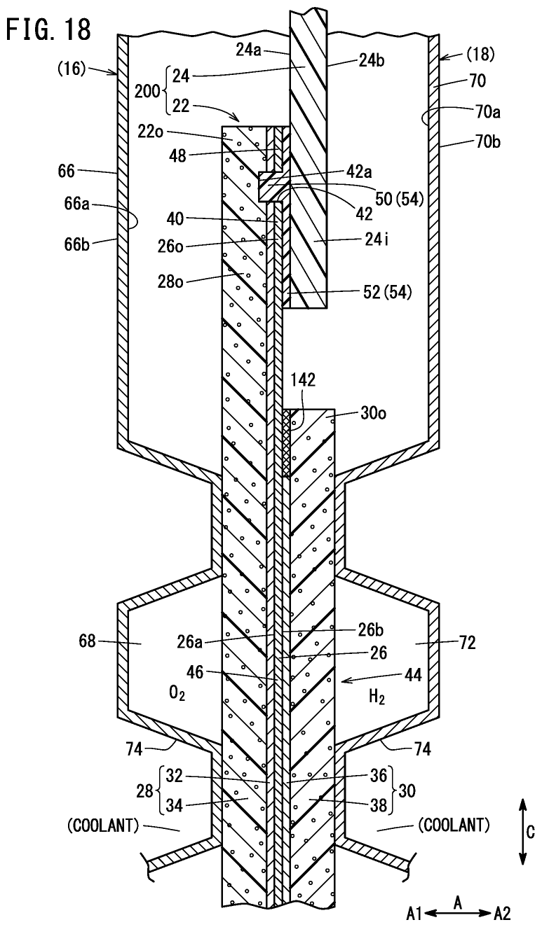

Moreover, as in the resin frame equipped MEA 200 shown in FIG. 18, it is also possible for both the first ion flow blocking member 50 in the first embodiment, and the second altered section (the third ion flow blocking member 142) in the second embodiment to be provided.

As has been described above, in the present embodiments, there is disclosed the resin frame equipped MEA (10, 120, 200) of the electrical power generating cell (12, 110) for the fuel cell, comprising the MEA (22, 122) including the electrolyte membrane (26), the first electrode (28) disposed on the first surface (26a) of the electrolyte membrane, and the second electrode (30) disposed on the second surface (26b) of the electrolyte membrane, and the resin frame member (24, 124) attached to the outer peripheral portion (22o, 122o) of the MEA and that projects outwardly from the outer peripheral portion, wherein the electrolyte membrane includes the outer peripheral overlapping portion (40) that overlaps with the inner peripheral portion (24i, 134) of the resin frame member, the ion flow blocking member (50, 140) that blocks the flow of ions is disposed on the outer peripheral overlapping portion, and the ion flow blocking member is formed in an annular shape surrounding the electrical power generating region (44) of the MEA.

In the electrolyte membrane, the ion flow blocking member blocks the iron ions, the copper ions, or the like outside the electrical power generating region. Accordingly, the iron ions, the copper ions, or the like are prevented from entering into the electrical power generating region of the MEA. Consequently, it is possible to prevent the electrical power generating region of the MEA from suffering from deterioration due to the influence of the iron ions, the copper ions, or the like. More specifically, the MEA can be chemically protected.

One typical example of the ion flow blocking member is a physical barrier. As a specific example of the physical barrier, there may be cited the convex portion. More specifically, in the above described embodiments, there is disclosed the resin frame equipped MEA, in which the outer peripheral portion of the MEA includes the groove (42) that penetrates in the thickness direction through at least the outer peripheral overlapping portion of the electrolyte membrane, and the ion flow blocking member (50) is a convex portion that has entered into the groove.

The groove may be formed from the electrolyte membrane and throughout the first electrode. More specifically, in the present embodiments, there is disclosed the resin frame equipped MEA, in which the outer peripheral portion of the first electrode overlaps with the outer peripheral overlapping portion of the electrolyte membrane, and the groove is formed by the outer peripheral overlapping portion of the electrolyte membrane, and the outer peripheral portion of the first electrode. In this case, the ion flow blocking member enters into the groove up to a portion that reaches the first electrode.

In the present embodiments, there is disclosed the resin frame equipped MEA, in which the convex portion forming the ion flow blocking member is provided by the adhesive (54) that joins to each other the inner peripheral portion of the resin frame member and the outer peripheral overlapping portion of the electrolyte membrane.

In the case that a portion of the adhesive is used as the ion flow blocking member, a material for forming the convex portion need not be coated, separate from the adhesive, on the electrolyte membrane. Therefore, the ion flow blocking member is easily manufactured.

Another typical example of the ion flow blocking member is a chemical barrier. In this case, a portion of the outer peripheral overlapping portion of the electrolyte membrane is chemically altered. More specifically, in the present embodiments, there is disclosed the resin frame equipped MEA, in which the ion flow blocking member is formed as the first altered section (140), in which a portion of the outer peripheral overlapping portion of the electrolyte membrane is chemically altered in an annular shape.

A typical example of the material used for the electrolyte membrane in the fuel cell is a solid polymer having a functional group. In this case, due to chemically bonding a certain type of cations other than iron ions or copper ions to the functional group, the electrolyte membrane can be chemically altered. More specifically, in the present embodiments, there is disclosed the resin frame equipped MEA, in which the material of the electrolyte membrane is a solid polymer having a functional group, and the first altered section is a portion in which the functional group is chemically bonded with cations other than iron ions or copper ions.

A typical embodiment of the material used for the electrolyte membrane is a solid polymer having a sulfonic acid group (for example, perfluorosulfonic acid). Further, the cations are preferably cesium ions, lead ions, silver ions, or alkaline earth metal ions. More specifically, in the present embodiments, there is disclosed the resin frame equipped MEA, in which the functional group is a sulfonic acid group, and the cations are cesium ions, lead ions, silver ions, or alkaline earth metal ions.

In the present embodiments, there is disclosed the resin frame equipped MEA, wherein the second electrode includes the electrode catalyst layer (36), the electrode catalyst layer is a layer containing an electrode catalyst and an ionic conductive polymer having a functional group, and the second altered section (142) of an annular shape in which the ion conductive polymer in the outer peripheral portion of the electrode catalyst layer is chemically altered.

The ion conductive polymer assists the conduction of ions within the electrode catalyst layer. The second altered section is formed by chemically altering the ion conductive polymer. Moreover, the ion conductive polymer is typically contained as a binder within the electrode catalyst layer.

The second altered section blocks the iron ions, the copper ions, or the like. More specifically, the second altered section serves as an ion flow blocking member in the form of a chemical barrier. In this case, due to the second altered section, movement of the iron ions, the copper ions, or the like to the electrolyte membrane along the second electrode is suppressed. Accordingly, the electrolyte membrane can be more effectively protected.

In order to chemically alter the ionic conductive polymer, for example, cations other than iron ions or copper ions are chemically bonded with the functional group of the ionic conductive polymer. More specifically, in the present embodiments, there is disclosed the resin frame equipped MEA, in which the second altered section is formed by chemically bonding the functional group with cations other than iron ions or copper ions.

A typical example of the ionic conductive polymer is a solid polymer having a sulfonic acid group (for example, perfluorosulfonic acid). In this case, the cations are preferably cesium ions, lead ions, silver ions, or alkaline earth metal ions. More specifically, in the present embodiments, there is disclosed the resin frame equipped MEA, in which the functional group is a sulfonic acid group, and the cations are cesium ions, lead ions, silver ions, or alkaline earth metal ions.

Further, in the present embodiments, there is disclosed the method of manufacturing the resin frame equipped MEA (10, 120, 200) of the electrical power generating cell (12, 110) for the fuel cell, wherein the resin frame equipped MEA comprises the MEA (22, 122) including the electrolyte membrane (26), the first electrode (28) disposed on the first surface (26a) of the electrolyte membrane, and the second electrode (30) disposed on the second surface (26b) of the electrolyte membrane, and the resin frame member (24, 124) attached to the outer peripheral portion (22o, 122o) of the MEA and that projects outwardly from the outer peripheral portion, the method of manufacturing comprising the stacking step of obtaining the stacked body (80) by stacking the electrolyte membrane on the first electrode, the joining step of forming the outer peripheral overlapping portion (40) on the electrolyte membrane by superimposing the inner peripheral portion (24i) of the resin frame member on the outer peripheral portion of the electrolyte membrane on which the first electrode is stacked, and joining the inner peripheral portion of the resin frame member to the outer peripheral overlapping portion of the electrolyte membrane, and the blocking member forming step of disposing, after the stacking step, the ion flow blocking member (50, 140, 142) that blocks the flow of ions on the outer peripheral overlapping portion of the electrolyte membrane, wherein the ion flow blocking member is formed in an annular shape surrounding the electrical power generating region (44) of the MEA.

In certain cases, the blocking member forming step may be performed before the joining step. Conversely thereto, the joining step may be performed before the blocking member forming step. Therefore, the order of the joining step and the blocking member forming step is not limited.

By performing the steps described above, the resin frame equipped MEA including the ion flow blocking member can be easily obtained.

In order to obtain the ion flow blocking member in the form of a convex portion that serves as a physical barrier, the groove is formed in the outer peripheral overlapping portion of the electrolyte membrane. The convex portion that enters into the groove is formed to serve as the ion flow blocking member. More specifically, in the present embodiments, there is disclosed the method of manufacturing the resin frame equipped MEA, in which the outer peripheral portion of the MEA includes the groove (42) that penetrates in the thickness direction through at least the outer peripheral overlapping portion of the electrolyte membrane, the joining step is performed in a state in which the material forming the ion flow blocking member is filled in the groove, and the ion flow blocking member is obtained as a convex portion that has entered into the groove.

The groove can be formed, for example, by way of laser machining. More specifically, in the present embodiments, there is disclosed the method of manufacturing the resin frame equipped MEA, in which, in the groove forming step, the groove is formed in the outer peripheral overlapping portion of the electrolyte membrane by way of laser machining. In accordance with such laser machining, it is easy to form the groove.

In the present embodiment, there is disclosed the resin frame equipped MEA, in which the ion flow blocking member is the adhesive (54) that joins to each other the inner peripheral portion of the resin frame member and the outer peripheral overlapping portion of the electrolyte membrane.

In this case, since a portion of the adhesive is used as the ion flow blocking member, there is no need for a material separate from the adhesive to be coated on the electrolyte membrane in order to form the convex portion. Therefore, the operation of manufacturing the ion flow blocking member is simplified.

In order to obtain the ion flow blocking member in the form of a chemical barrier, a portion of the outer peripheral overlapping portion of the electrolyte membrane is chemically altered. More specifically, in the present embodiment, there is disclosed the resin frame equipped MEA, wherein the ion flow blocking member is the first altered section (140) of an annular shape, in which a portion of the outer peripheral overlapping portion of the electrolyte membrane is chemically altered.

As discussed previously, in the case that the material of the electrolyte membrane in the fuel cell is a solid polymer having a functional group, cations other than iron ions or copper ions are chemically bonded with the functional group. More specifically, in the present embodiments, there is disclosed the method of manufacturing the resin frame equipped MEA, in which the material of the electrolyte membrane is a solid polymer having a functional group, and the first altered section is obtained by chemically bonding the functional group with cations other than iron ions or copper ions.

In the case that the material of the electrolyte membrane is a solid polymer having a sulfonic acid group (for example, perfluorosulfonic acid), cesium ions, lead ions, silver ions, or alkaline earth metal ions are bonded with respect to the sulfonic acid group. More specifically, in the present embodiments, there is disclosed the method of manufacturing the resin frame equipped MEA, in which the functional group is a sulfonic acid group, and the first altered section is obtained by chemically bonding the sulfonic acid group with cesium ions, lead ions, silver ions, or alkaline earth metal ions.

In the present embodiments, there is disclosed the method of manufacturing the resin frame equipped MEA, further comprising the step of coating a liquid (160) containing the cations on the electrolyte membrane.

In accordance with this feature, the cations can be easily imparted to the sulfonic acid group. Accordingly, by means of a simple operation, it is possible for the cations to be bonded with the sulfonic acid group. Stated otherwise, it is easy for a portion of the electrolyte membrane to be chemically altered. Moreover, as a suitable specific example of a liquid containing barium ions, there may be cited an aqueous solution of barium chloride.

In the present embodiment, there is disclosed the method of manufacturing the resin frame equipped MEA, in which the second electrode includes the electrode catalyst layer (36), and the electrode catalyst layer is a layer containing an electrode catalyst and an ionic conductive polymer having a functional group, and further comprising the step of obtaining the second altered section (142) of an annular shape by chemically bonding the functional group of the ionic conductive polymer on the outer peripheral portion of the second electrode with cations other than ion ions or copper ions.

By the second altered section, the ion flow blocking member in the form of a chemical barrier is formed on the second electrode. Since the second altered section also blocks the iron ions, the copper ions, or the like, movement of the iron ions, the copper ions, or the like to the electrolyte membrane along the second electrode is suppressed. Accordingly, the electrolyte membrane can be more effectively protected.

In the case that the ionic conductive polymer is a polymer (for example, perfluorosulfonic acid) having the sulfonic acid group, cesium ions, lead ions, silver ions or alkali earth metal ions are bonded with respect to the sulfonic acid group. More specifically, in the present embodiments, there is disclosed the method for manufacturing the resin frame equipped MEA, in which the ionic conductive polymer includes the sulfonic acid group as the functional group, and the second altered section is obtained by chemically bonding cesium ions, lead ions, silver ions, or alkaline earth metal ions with the sulfonic acid group.

In the present embodiments, there is disclosed the method of manufacturing the resin frame equipped MEA, further comprising the step of coating the second electrode with the liquid (160) containing the cations.

In this case as well, in the same manner as described previously, the cations can be easily imparted to the sulfonic acid group. Accordingly, by means of a simple operation, it is possible for the cations to be bonded with the sulfonic acid group. More specifically, it is easy for a portion of the second electrode to be chemically altered. A suitable specific example of the liquid in the case of chemically altering the portion of the second electrode, in the same manner as described previously, is an aqueous solution of barium chloride.

Both the first altered section and the second altered section may be formed. In this case, the step of forming the second altered section can be included in the blocking member forming step. For example, the liquid containing the cations is coated on the outer peripheral overlapping portion of the electrolyte membrane, and the liquid containing the cations is coated on the outer peripheral portion of the second electrode.

The present invention is not limited to the embodiments described above, and it goes without saying that various modified or additional configurations could be adopted therein without departing from the essence and gist of the present invention.

For example, in the first embodiment, the resin frame member 124 in which two individual members are joined together may be used, in the same manner as in the second embodiment. Conversely, in the second embodiment, the resin frame member 24 made up from a single individual member may be used, in the same manner as in the first embodiment.

What is claimed is:

1. A resin frame equipped membrane electrode assembly of an electrical power generating cell for a fuel cell, comprising:
a membrane electrode assembly including an electrolyte membrane, a first electrode disposed on a first surface of the electrolyte membrane, and a second electrode disposed on a second surface of the electrolyte membrane; and
a resin frame member attached to an outer peripheral portion of the membrane electrode assembly and configured to project outwardly from the outer peripheral portion;
wherein the electrolyte membrane includes an outer peripheral overlapping portion configured to overlap with an inner peripheral portion of the resin frame member;
an ion flow blocking member configured to block a flow of ions is disposed on the outer peripheral overlapping portion; and
the ion flow blocking member is formed in an annular shape surrounding an electrical power generating region of the membrane electrode assembly.

2. The resin frame equipped membrane electrode assembly according to claim 1, wherein:
the outer peripheral portion of the membrane electrode assembly includes a groove configured to penetrate in a thickness direction through at least the outer peripheral overlapping portion of the electrolyte membrane; and
the ion flow blocking member is a convex portion that has entered into the groove.

3. The resin frame equipped membrane electrode assembly according to claim 2, wherein:
the outer peripheral portion of the first electrode overlaps with the outer peripheral overlapping portion of the electrolyte membrane; and
the groove is formed by the outer peripheral overlapping portion of the electrolyte membrane, and the outer peripheral portion of the first electrode.

4. The resin frame equipped membrane electrode assembly according to claim 2, wherein the convex portion forming the ion flow blocking member is provided by an adhesive configured to join to each other the inner peripheral portion of the resin frame member and the outer peripheral overlapping portion of the electrolyte membrane.

5. The resin frame equipped membrane electrode assembly according to claim 1, wherein the ion flow blocking member is a first altered section of an annular shape, in which a portion of the outer peripheral overlapping portion of the electrolyte membrane is chemically altered.

6. The resin frame equipped membrane electrode assembly according to claim 5, wherein the material of the electrolyte membrane is a solid polymer having a functional group, and the first altered section is a portion in which the functional group is chemically bonded with cations other than iron ions or copper ions.

7. The resin frame equipped membrane electrode assembly according to claim 6, wherein the functional group is a sulfonic acid group, and the cations are cesium ions, lead ions, silver ions, or alkaline earth metal ions.

8. The resin frame equipped membrane electrode assembly according to claim 1, wherein:
the second electrode includes an electrode catalyst layer wherein the electrode catalyst layer is a layer containing an electrode catalyst and an ionic conductive polymer having a functional group; and
a second altered section of an annular shape in which the ion conductive polymer in an outer peripheral portion of the electrode catalyst layer is chemically altered.

9. The resin frame equipped membrane electrode assembly according to claim 8, wherein the second altered section is formed by chemically bonding the functional group with cations other than iron ions or copper ions.

10. The resin frame equipped membrane electrode assembly according to claim 9, wherein the functional group is a sulfonic acid group, and the cations are cesium ions, lead ions, silver ions, or alkaline earth metal ions.

11. A method of manufacturing a resin frame equipped membrane electrode assembly of an electrical power generating cell for a fuel cell;
wherein the resin frame equipped membrane electrode assembly comprises:
a membrane electrode assembly including an electrolyte membrane, a first electrode disposed on a first surface of the electrolyte membrane, and a second electrode disposed on a second surface of the electrolyte membrane; and
a resin frame member attached to an outer peripheral portion of the membrane electrode assembly and configured to project outwardly from the outer peripheral portion;
the method of manufacturing comprising:
a stacking step of obtaining a stacked body by stacking the electrolyte membrane on the first electrode;
a joining step of forming an outer peripheral overlapping portion on the electrolyte membrane by superimposing an inner peripheral portion of the resin frame member on the outer peripheral portion of the electrolyte membrane on which the first electrode is stacked, and joining the inner peripheral portion of the resin frame member to the outer peripheral overlapping portion of the electrolyte membrane; and
a blocking member forming step of disposing, after the stacking step, an ion flow blocking member configured to block a flow of ions on the outer peripheral overlapping portion of the electrolyte membrane;
wherein the ion flow blocking member is formed in an annular shape surrounding an electrical power generating region of the membrane electrode assembly.

12. The method of manufacturing the resin frame equipped membrane electrode assembly according to claim 11, wherein:
the outer peripheral portion of the membrane electrode assembly includes a groove configured to penetrate in a thickness direction through at least the outer peripheral overlapping portion of the electrolyte membrane;
the joining step is performed in a state in which a material forming the ion flow blocking member is filled in the groove; and
the ion flow blocking member is obtained as a convex portion that has entered into the groove.

13. The method of manufacturing the resin frame equipped membrane electrode assembly according to claim 12, wherein in the groove forming step, the groove is formed in the outer peripheral overlapping portion of the electrolyte membrane by way of laser machining.

14. The method of manufacturing the resin frame equipped membrane electrode assembly according to claim 12, wherein the ion flow blocking member is produced from an adhesive configured to join to each other the inner peripheral portion of the resin frame member and the outer peripheral overlapping portion of the electrolyte membrane.

15. The method of manufacturing the resin frame equipped membrane electrode assembly according to claim 11, wherein the ion flow blocking member is formed as a first altered section, in which a portion of the outer peripheral overlapping portion of the electrolyte membrane is chemically altered in an annular shape.

16. The method of manufacturing the resin frame equipped membrane electrode assembly according to claim 15, wherein the material of the electrolyte membrane is a solid polymer having a functional group, and the first altered section is obtained by chemically bonding the functional group with cations other than iron ions or copper ions.

17. The method of manufacturing the resin frame equipped membrane electrode assembly according to claim 16, wherein the functional group is a sulfonic acid group, and the first altered section is obtained by chemically bonding the sulfonic acid group with cesium ions, lead ions, silver ions, or alkaline earth metal ions.

18. The method of manufacturing the resin frame equipped membrane electrode assembly according to claim 17, further comprising a step of coating a liquid containing the cations to the electrolyte membrane.

19. The method of manufacturing the resin frame equipped membrane electrode assembly according to claim 11, wherein:
the second electrode includes an electrode catalyst layer, and the electrode catalyst layer is a layer containing an electrode catalyst and an ionic conductive polymer having a functional group; and
further comprising a step of obtaining a second altered section of an annular shape by chemically bonding the functional group of the ionic conductive polymer on an outer peripheral portion of the second electrode with cations other than ion ions or copper ions.

20. The method of manufacturing the resin frame equipped membrane electrode assembly according to claim 19, wherein the ion conductive polymer includes a sulfonic acid group as the functional group, and the second altered section is obtained by chemically bonding cesium ions, lead ions, silver ions, or alkaline earth metal ions to the sulfonic acid group.

21. The method of manufacturing the resin frame equipped membrane electrode assembly according to claim 20, further comprising a step of coating the second electrode with a liquid containing the cations.
